(19) United States
(12) Patent Application Publication
(10) Pub. No.: US 2019/0372216 A1
(43) Pub. Date: Dec. 5, 2019

(54) MAGNETIC SHIELDING SHEET AND ANTENNA DEVICE INCLUDING THE SAME

(71) Applicant: WITS Co., Ltd., Yongin-si (KR)

(72) Inventors: Hyun Jung LEE, Suwon-si (KR); Jae Hyuk JANG, Suwon-si (KR); Jae Kwang LEE, Suwon-si (KR); Yeong Hwan SONG, Suwon-si (KR); Jae Sun WON, Suwon-si (KR)

(73) Assignee: WITS Co., Ltd., Yongin-si (KR)

(21) Appl. No.: 16/185,047

(22) Filed: Nov. 9, 2018

(30) Foreign Application Priority Data
May 29, 2018 (KR) 10-2018-0060910

(51) Int. Cl. H01Q 1/52

(52) U.S. Cl. CPC H01Q 1/526

(57) ABSTRACT

A magnetic shielding sheet and an antenna device including a magnetic shielding sheet. The magnetic shielding sheet includes a first hole disposed in a position corresponding to a position of a second hole formed in a substrate to which the magnetic shielding sheet is attached, and a groove extending from the first hole to an edge of the magnetic shielding sheet.

### CROSS-REFERENCE TO RELATED APPLICATION

This application claims the benefit under 35 USC 119(a) of Korean Patent Application No. 10-2018-0060910 filed on May 29, 2018 in the Korean Intellectual Property Office, the entire disclosure of which is incorporated herein by reference for all purposes.

### BACKGROUND

### 1. Field

The following description relates to a magnetic shielding sheet and an antenna device including the same.

### 2. Description of Related Art

An information communication device such as a portable terminal, or the like, includes an antenna device for performing wireless electrical charging or the transmission and reception of data using a scheme such as Near Field Communications (NFC), Magnetic Secure Transmission (MST), or the like.

Such an antenna device includes a magnetic shielding sheet to prevent deteriorations in the performance of electromagnetic waves generated by various factors or to effectively shield electromagnetic waves.

In addition, an antenna device may include one or more holes formed due to an internal structure of an apparatus in which the antenna device is to be disposed, for the purpose of assembling parts, or the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a magnetic shielding sheet includes a first hole disposed in a position corresponding to a position of a second hole formed in a substrate to which the magnetic shielding sheet is attached, and a groove extending from the first hole to an edge of the magnetic shielding sheet.

The edge of the magnetic shielding sheet may be an edge that is closest to the first hole, among edges of the magnetic shielding sheet.

The first hole may be disposed in an area adjacent to the edge of the magnetic shielding. sheet

In another general aspect, an antenna device includes a substrate having a first hole, an antenna pattern disposed on the substrate, and a magnetic shielding sheet stacked on the substrate, the magnetic shielding sheet including a second hole disposed in a position corresponding to a position of the first hole and a first groove extending from the second hole to an edge of the magnetic shielding sheet.

A size of the first hole may be 0.3 to 0.9 times a size of the second hole.

The edge of the magnetic shielding sheet may be an edge that is closest to the second hole, among edges of the magnetic shielding sheet.

The antenna device may include an adhesive or a high molecular substance disposed in at least a portion of the groove.

The antenna device may include an adhesive layer disposed between the substrate and the magnetic shielding sheet to fix the substrate and the magnetic shielding sheet, and the adhesive layer may include a third hole disposed in a position corresponding to the position of the first hole.

The adhesive layer may include a second groove disposed in a position corresponding to a position of the first groove.

The antenna device may include a protective film stacked on the magnetic shielding sheet to protect the magnetic shielding sheet from external impacts, and the protective film may include a third hole disposed in a position corresponding to the position of the first hole.

The protective film may include a second groove disposed in a position corresponding to a position of the first groove.

The protective film may cover the magnetic shielding sheet inside of the second hole.

The antenna apparatus may include a heat radiation sheet stacked on the magnetic shielding sheet to discharge heat generated by the substrate externally, and the heat radiation sheet may include a third hole disposed in a position corresponding to the position of the first hole.

The antenna pattern may be a power reception pattern to receive power transmitted wirelessly.

The antenna pattern may be a data transmission and reception antenna pattern to transmit and receive data according to near field communication or magnetic secure transmission.

In another general aspect, an apparatus includes an antenna device. The antenna device includes a substrate having a first hole having a first diameter, an antenna pattern disposed on the substrate, and a magnetic shielding sheet stacked on the substrate. The magnetic shielding sheet includes a second hole disposed in a position corresponding to a position of the first hole, and the second hole has a second diameter that is larger than the first diameter.

A length of the first diameter may be 0.3 to 0.9 times a length of the second diameter.

Other features and aspects will be apparent from the following detailed description, the drawings, and the claims.

### BRIEF DESCRIPTION OF DRAWINGS

FIG. 1 is a view schematically illustrating a configuration of a magnetic shielding sheet according to an example.

FIG. 2 is a view schematically illustrating a configuration of an antenna device including a magnetic shielding sheet according to an example.

FIG. 3A is a view schematically illustrating a configuration of a cross-section of an antenna device according to an example.

FIG. 3B is a view schematically illustrating a configuration of a cross-section of an antenna device according to an example.

FIG. 4A is a view schematically illustrating a configuration of a cross-section of an antenna device according to an example.

FIG. 4B is a view schematically illustrating a configuration of a cross-section of an antenna device according to an example.

FIG. 5A is a view schematically illustrating a configuration of a cross-section of an antenna device according to an example.

FIG. 5B is a view schematically illustrating a configuration of a cross-section of an antenna device according to an example.

FIG. 6A is a view schematically illustrating a configuration of a cross-section of an antenna device according to an example.

FIG. 6B is a view schematically illustrating a configuration of a cross-section of an antenna device according to an example.

FIG. 7 is a view schematically illustrating a magnetic shield sheet and a substrate of an antenna device according to an exemplary embodiment in the present disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

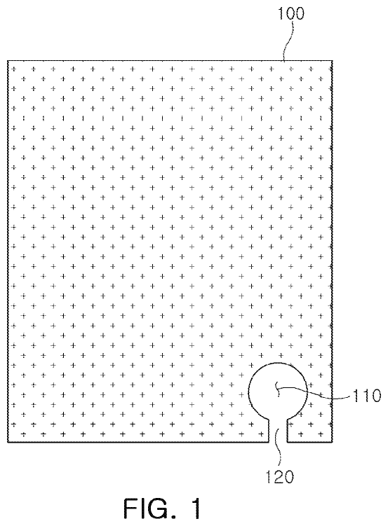

FIG. 1 is a view schematically illustrating a configuration of a magnetic shielding sheet.

A magnetic shielding sheet 100 has a hole 110 formed in the magnetic shielding sheet 100, and has a groove 120 having a predetermined (certain) width from the hole formed in the magnetic shielding sheet 100 to one side of the magnetic shielding sheet 100.

One or more holes may be formed in the magnetic shielding sheet 100 according to an internal structure of the equipment, in which the antenna device including the magnetic shielding sheet is to be placed, for the purpose of assembling the parts, or the like. As illustrated in FIG. 1, the hole 110 may be formed near an edge of the magnetic shielding sheet 100. Although not illustrated, the hole may be formed in a portion near one side of the magnetic shielding sheet 100, which is not near the edge.

A groove 120 having a predetermined width from the hole 110 to one side of the magnetic shielding sheet 100 is formed. The groove 120 may be formed to a side surface closest to the hole among the side surfaces of the magnetic shielding sheet 100. The magnetic shielding sheet 100 has an open hole structure in which a portion of the magnetic shielding sheet 100 is open.

The magnetic shielding sheet 100 may be present in locations except for a location of the hole. Therefore, a shielding function may be further improved. By producing a portion of the magnetic shielding sheet 100 open by virtue of the groove 120, for example, it is possible to prevent the magnetic shielding sheet 100 from being torn around the hole 110. The production yield of the magnetic shielding sheet may be improved, and the magnetic shielding sheet 100 and an antenna device including the magnetic shielding sheet 100 may be easily produced.

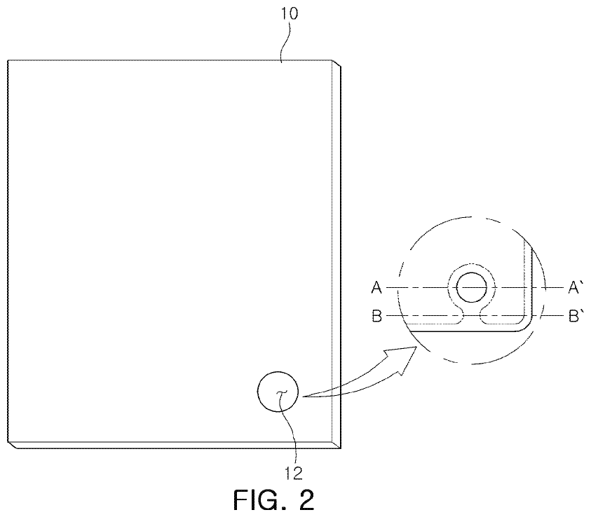

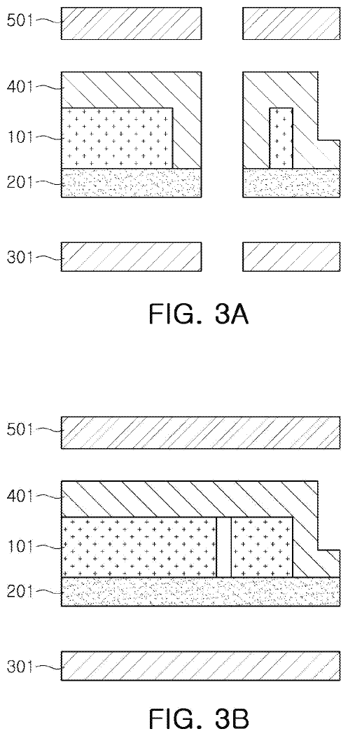

FIG. 2 is a view schematically illustrating a configuration of a plane of an antenna device 10 including a magnetic shielding sheet, and each of FIGS. 3A, 3B, 4A, 4B, 5A, 5B, 6A, and 6B are views schematically illustrating a configuration of a cross-section of the antenna device 10 including a magnetic shielding sheet.

The antenna device 10 includes a hole 12 penetrating an inside of the antenna device. The antenna device 10 may include a substrate on which an antenna pattern is formed and a magnetic shielding sheet, such as the magnetic shielding sheet 100, stacked on the substrate.

FIGS. 3A and 3B are views schematically illustrating a configuration of a cross-section of an antenna device. FIG. 3A illustrates a cross-section taken along line A-A′ of FIG. 2, and FIG. 3B illustrates a cross-section taken along line B-B′ of FIG. 2.

The antenna device may include a magnetic shielding sheet 101, an adhesive layer 201, a substrate 301, a protective film 401, and a heat radiation sheet 501.

An antenna pattern may be formed on the substrate 301. The antenna pattern may be a power receiving antenna pattern for receiving power wirelessly or a data transmission and reception antenna pattern for transmitting and receiving data in various manners (for example, Near Field Communication (NFC) or magnetic secure transmission (MST)). Both the power reception antenna pattern and the data transmission and reception antenna pattern may be formed on the substrate 301.

The adhesive layer 201 may be disposed on an upper surface of the substrate 301, such that the magnetic shielding sheet 101 is fixed on the substrate 301.

The magnetic shielding sheet 101 may be disposed on the upper surface of the adhesive layer 201. The magnetic shielding sheet 101 may be composed of a single layer, or may have a stacked structure in which a plurality of layers is stacked. The magnetic shielding sheet 101 may shield electromagnetic waves and may prevent deterioration of wireless power efficiency and/or deterioration of data transmitting efficiency. The magnetic shielding sheet 101 may be disposed in an area around the hole, thereby significantly reducing the deterioration of the shielding function in that area. An influence of the presence of the hole on the adhesion of the heat radiation sheet 501 is reduced such that the heat radiation sheet 501, or the like may be disposed around the hole, and the antenna device may have a sufficient heat radiation performance.

The protective film 401 may be disposed on an upper surface of the magnetic shielding sheet 101, and may protect the magnetic shielding sheet 101 from external impacts.

The heat radiation sheet 501 may be disposed on an upper surface of the protective film 401, and may discharge heat generated by the substrate 301, or the like, externally.

As illustrated in FIG. 3A, respective holes may be formed in the same portions of the magnetic shielding sheet 101, the adhesive layer 201, the substrate 301, the protective film 401, and the heat radiation sheet 501, and the hole 12 of the antenna device 10 illustrated in FIG. 2 may be formed. Such a hole may be formed for the purpose of component assembly, or the like.

Inside the hole, the protective film 401 may be formed to surround the magnetic shielding sheet 101 such that the magnetic shielding sheet 101 is not directly exposed to the hole.

As illustrated in FIG. 3B, the magnetic shielding sheet 101 may include a groove formed from the hole to one side of the antenna device. The substrate 301, the adhesive layer 201, the protective film 401, and the heat radiation sheet 501 may all be formed to cover the top and bottom of the groove. Thus, the structural stability of the magnetic shielding sheet 101 and the antenna device including the magnetic shielding sheet may be secured.

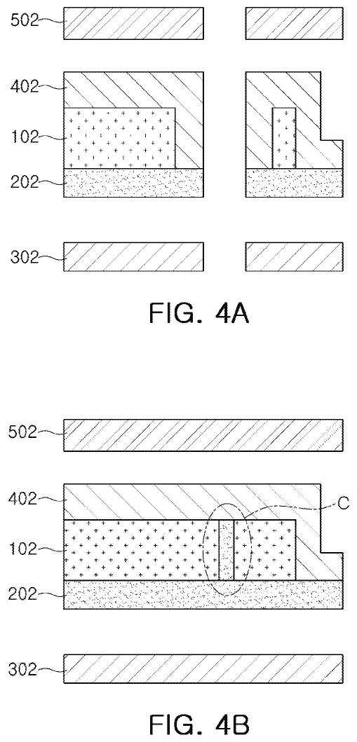

FIGS. 4A and 4B are views schematically illustrating a configuration of a cross-section of an antenna device according to an example. FIG. 4A illustrates a cross-section taken along line A-A′ of FIG. 2, and FIG. 4B illustrates a cross-section taken along line B-B′ of FIG. 2.

The antenna device may include a magnetic shielding sheet 102, an adhesive layer 202, a substrate 302, a protective film 402, and a heat radiation sheet 502.

The example illustrated in FIGS. 4A and 4B is the same as the example illustrated in FIGS. 3A and 3B, except that a groove of the magnetic shielding sheet 102 (C of FIG. 4B) is filled with an adhesive or a high molecular substance. By filling the groove C with the adhesive or the high molecular substance, penetration of a foreign substance, moisture, or the like into the magnetic shielding sheet 102 may be effectively prevented, and a separated portion of the magnetic shielding sheet 102 may be connected to improve the structural stability. FIGS. 4A and 4B illustrate that the entirety of the groove C is filled with the adhesive or the high molecular substance, but the adhesive or the high molecular substance may be filled in only a portion of the groove C.

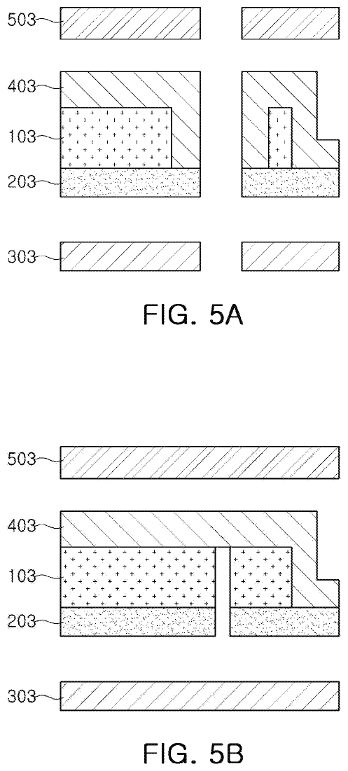

FIGS. 5A and 5B are views schematically illustrating a configuration of a cross-section of an antenna device. FIG. 5A illustrates a cross-section taken along line A-A′ of FIG. 2, and FIG. 5B illustrates a cross-section taken along line B-B′ of FIG. 2.

The antenna device may include a magnetic shielding sheet 103, an adhesive layer 203, a substrate 303, a protective film 403, and a heat radiation sheet 503.

The example illustrated in FIGS. 5A and 5B is the same as the example illustrated in FIGS. 3A and 3B, except that the adhesive layer 203 is not present in a portion in which the groove is formed. The adhesive layer 203 may include a groove formed in an area corresponding to the groove formed in the magnetic shielding sheet 103.

The groove of the magnetic shielding sheet 103 and the groove of the adhesive layer 203 may not coincide with each other. The groove of the magnetic shielding sheet 103 may be larger than the groove of the adhesive layer 203, and conversely, the groove of the adhesive layer 203 may be larger than the groove of the magnetic shielding sheet 103.

An adhesive material may be present on some or all of the portions in which the groove is formed in the magnetic shielding sheet 103. For example, when an adhesive layer is present between the protective film 403 and the magnetic shielding sheet 103, or when an adhesive material may be present for adhering to the magnetic shielding sheet 103 on at least one surface of the protective film 403, the adhesive material may be present on some or all of the portions in which the groove is formed in the magnetic shielding sheet 103.

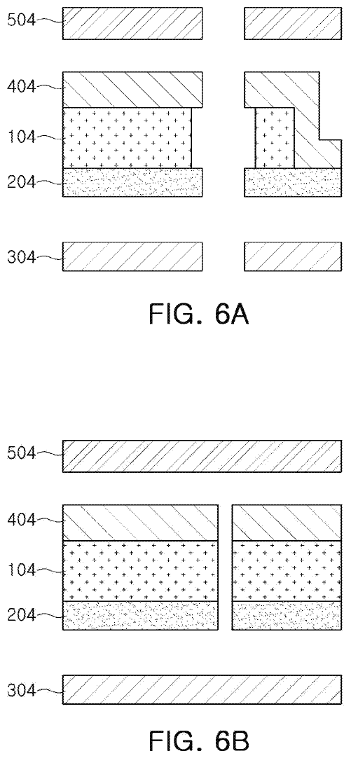

FIGS. 6A and 6B are views schematically illustrating a configuration of a cross-section of an antenna device. FIG. 6A illustrates a cross-section taken along line A-A′ of FIG. 2, and FIG. 6B illustrates a cross-section taken along line B-B′ of FIG. 2.

An antenna device may include a magnetic shielding sheet 104, an adhesive layer 204, a substrate 304, a protective film 404, and a heat radiation sheet 504.

The example illustrated in FIGS. 6A and 6B is the same as the example illustrated in FIGS. 3A and 3B, except that the magnetic shielding sheet 104 is exposed inside the hole, as illustrated in FIG. 6A, and the adhesive layer 204 and the protective film 404 are not present in a portion in which a groove is formed, as illustrated in FIG. 6B. The protective film 404 may not cover the magnetic shielding sheet 104 inside the hole. The adhesive layer 203 and the protective film 404 may include a groove formed in an area corresponding to an area in which the groove is formed in the magnetic shielding sheet 104.

FIGS. 3A, 3B, 4A, 4B, 5A, 5B, 6A, and 6B illustrate examples in which the antenna device includes a substrate, an adhesive layer, a magnetic shielding sheet, a protective film and a heat radiation sheet, but an antenna device is not limited to such a configuration. For example, when the magnetic shielding sheet has adhesive force or when the adhesive layer is unnecessary for any other reasons, the adhesive layer may be excluded. When the heat radiation sheet is not required because a heating problem is not great or for any other reasons, the heat radiation sheet may be excluded. The protective film may also be excluded.

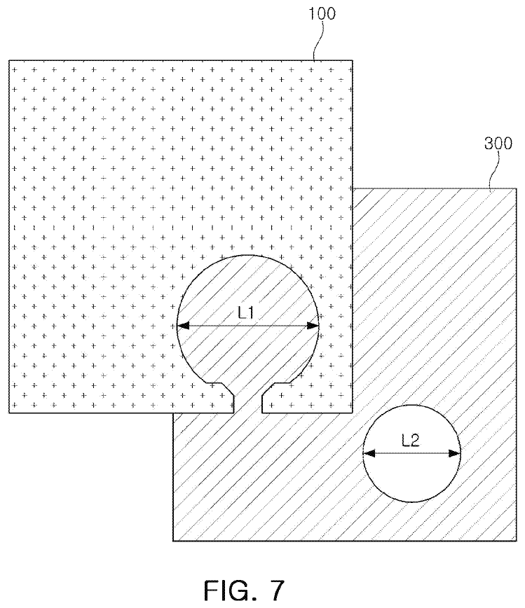

FIG. 7 is a view schematically illustrating a magnetic shielding sheet and a substrate of an antenna device.

As illustrated in FIG. 7, a magnetic shielding sheet 100 and a substrate 300 may include holes formed in the same (corresponding) positions. The size of the hole formed in the magnetic shielding sheet 100 may be larger than the size of the hole formed in the substrate 300. The size of the holes may be a diameter when the shape of the holes is circular. In a case in which the size of the hole formed in the magnetic shielding sheet 100 is L1, and the size of the hole formed in the substrate 300 is L2, L2/L1 may be a value between 0.3 to 0.9. In a case in which L2/L1 is smaller than 0.3, shielding function and performance deteriorations may occur. In a case in which L2/L1 is larger than 0.9, the sealing of the magnetic shielding sheet is not sufficient such that moisture may penetrate, or when the magnetic shielding sheet is assembled with the substrate, the processing hole may be covered or may be easily damaged.

According to a magnetic shielding sheet and an antenna device, even when one or more holes formed in the antenna device, the deterioration of the shielding function or the deterioration of the heat radiation performance may not occur, and tearing of the magnetic shielding sheet may be prevented.

A magnetic shielding sheet and an antenna device according to the disclosed examples may be incorporated with an electronic device, which may be any of a smartphone, a personal digital assistant, a digital video camera, a digital still camera, a network system, a computer, a monitor, a tablet, a laptop, a netbook, a television, a video game, a smart watch, an automotive, or the like, but is not limited to such devices.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A magnetic shielding sheet, comprising:
a first hole disposed in a position corresponding to a position of a second hole formed in a substrate to which the magnetic shielding sheet is attached; and
a groove extending from the first hole to an edge of the magnetic shielding sheet.

2. The magnetic shielding sheet according to claim 1, wherein the edge of the magnetic shielding sheet is an edge that is closest to the first hole, among edges of the magnetic shielding sheet.

3. The magnetic shielding sheet according to claim 1, wherein the first hole is disposed in an area adjacent to the edge of the magnetic shielding sheet.

4. An antenna device comprising:
a substrate comprising a first hole;
an antenna pattern disposed on the substrate; and
a magnetic shielding sheet stacked on the substrate, and comprising a second hole disposed in a position corresponding to a position of the first hole and a first groove extending from the second hole to an edge of the magnetic shielding sheet.

5. The antenna device according to claim 4, wherein a size of the first hole is 0.3 to 0.9 times a size of the second hole.

6. The antenna device according to claim 4, wherein the edge of the magnetic shielding sheet is an edge that is closest to the second hole, among edges of the magnetic shielding sheet.

7. The antenna device according to claim 4, further comprising an adhesive or a high molecular substance disposed in at least a portion of the groove.

8. The antenna device according to claim 4, further comprising an adhesive layer disposed between the substrate and the magnetic shielding sheet and configured to fix the substrate and the magnetic shielding sheet, the adhesive layer comprising a third hole disposed in a position corresponding to the position of the first hole.

9. The antenna device according to claim 8, wherein the adhesive layer comprises a second groove disposed in a position corresponding to a position of the first groove.

10. The antenna device according to claim 4, further comprising a protective film stacked on the magnetic shielding sheet and configured to protect the magnetic shielding sheet from external impacts, the protective film comprising a third hole disposed in a position corresponding to the position of the first hole.

11. The antenna device according to claim 10, wherein the protective film comprises a second groove disposed in a position corresponding to a position of the first groove.

12. The antenna device according to claim 10, wherein the protective film covers the magnetic shielding sheet inside of the second hole.

13. The antenna device according to claim 4, further comprising a heat radiation sheet stacked on the magnetic shielding sheet and configured to discharge heat generated by the substrate externally, the heat radiation sheet comprising a third hole disposed in a position corresponding to the position of the first hole.

14. The antenna device according to claim 4, wherein the antenna pattern is a power reception pattern configured to receive power transmitted wirelessly.

15. The antenna device according to claim 4, wherein the antenna pattern is a data transmission and reception antenna pattern configured to transmit and receive data according to near field communication or magnetic secure transmission.

16. An apparatus comprising:
an antenna device comprising:
a substrate comprising a first hole having a first diameter;
an antenna pattern disposed on the substrate; and
a magnetic shielding sheet stacked on the substrate, the magnetic shielding sheet comprising a second hole disposed in a position corresponding to a position of the first hole, the second hole having a second diameter that is larger than the first diameter.

17. The apparatus of claim 16, wherein a length of the first diameter is 0.3 to 0.9 times a length of the second diameter.
